(19) United States
(12) Patent Application Publication
(10) Pub. No.: US 2022/0309197 A1
(43) Pub. Date: Sep. 29, 2022

(54) AUTOMATED HARDENING OF SENSITIVE TRANSACTIONS

(71) Applicant: McAfee, LLC, San Jose, CA (US)

(72) Inventors: Jitesh Dattani, Bangalore (IN); Harsha Ramamurthy Joshi, Bangalore (IN); Saravana Kumar Ramalingam, Bangalore (IN); Srikanth Nalluri, Bangalore, Karnataka (IN); Sohan Lal, Bengalluru (IN); Siddartha Y. Ramamohan, Bengaluru (IN); Dattatraya Kulkarni, Bangalore (IN); Joseph Gullo, Pleasanton, CA (US)

(73) Assignee: McAfee, LLC, San Jose, CA (US)

(21) Appl. No.: 17/405,828

(22) Filed: Aug. 18, 2021

(30) Foreign Application Priority Data
Mar. 23, 2021 (IN) 202141012341

(51) Int. Cl. G06F 21/84; G06F 21/83; H04L 29/06; G06Q 20/40

(52) U.S. Cl. CPC G06F 21/84; G06F 21/83; H04L 63/0272; H04L 63/0236; G06Q 20/4014; G06Q 20/405

(57) ABSTRACT

There is disclosed, by way of example, a computing apparatus having a hardware platform having a processor and a memory; and instructions encoded within the memory to: identify an online transaction involving a user; according to a plurality of contextual factors, determine a sensitivity level for the online transaction; and according to the sensitivity level, contextually increase security for the online transaction without altering at least one other online transaction.

### CROSS REFERENCE TO RELATED APPLICATIONS

This application claims priority to Indian Provisional Application 2021410102341, titled “A MECHANISM TO IDENTIFY CONTEXT/SENSITIVITY OF A TRANSACTION AND TO PROTECT THE TRANSACTION BY AUTOMATED HARDENING AND MANAGEMENT OF THE TRANSACTION ENVIRONMENT,” filed Mar. 23, 2021, which is incorporated herein by reference.

### FIELD OF THE SPECIFICATION

The present specification relates generally to computer security, and more particularly to a system and method for hardening secure transactions.

### BACKGROUND

Sensitive transactions can include any transaction where sensitive or personal data may be shared or where compromise of shared data can represent a privacy or security risk to an end-user.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of a network.

FIG. 2 is a block diagram of selected elements of an endpoint device.

FIG. 3 is a block diagram of selected elements of a cloud service.

FIG. 4 is a block diagram of selected elements of a transaction protection environment.

FIG. 5 is a block diagram of selected aspects of determining context and sensitivity level.

FIG. 6 is a flow chart of selected aspects of a method of protecting a transaction.

FIG. 7 is an illustrative user interface element.

FIG. 8 is an illustrative user interface element.

FIG. 9 is a block diagram of selected elements of a hardware platform.

FIG. 10 is a block diagram of selected elements of a system-on-a-chip (SoC).

FIG. 11 is a block diagram of selected elements of a trusted execution environment (TEE).

FIG. 12 is a block diagram of selected elements of a network function virtualization (NFV) infrastructure.

FIG. 13 is a block diagram of selected elements of a containerization infrastructure.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computing apparatus. The computing apparatus also includes a hardware platform that may include a processor and a memory. The apparatus also includes instructions encoded within the memory to: identify an online transaction involving a user; according to a plurality of contextual factors, determine a sensitivity level for the online transaction; and according to the sensitivity level, contextually increase security for the online transaction without altering at least one other online transaction. The apparatus also includes the other embodiments of this aspect include corresponding computer systems, apparatus, and computer programs recorded on one or more computer storage devices, each configured to perform the actions of the methods.

Implementations may include one or more of the following features. The computing apparatus where the sensitivity level is selected from a set of discrete sensitivity levels. The one of the plurality of contextual factors is a user profile. The one of the plurality of contextual factors is a task type. The one of the plurality of contextual factors is an online service associated with the online transaction. The one of the plurality of contextual factors is a network on which the online transaction occurs. The one of the plurality of contextual factors is a device context. The one of the plurality of contextual factors is a browser context. Contextually increasing security may include disabling a key logger or screen grabber. Contextually increasing security may include adding one or more layers of authentication. Contextually increasing security may include auto-filling or clearing at least one field of a web form that calls for personally-identifying information. The at least one field is a non-mandatory field. Contextually increasing security may include hardening a web browser environment. Contextually increasing security may include enabling a virtual private network (VPN) tunnel. The VPN tunnel is specific to a browser tab. Contextually increasing security may include handling the online transaction via a remote cloud-based browser. Determining the sensitivity level may include querying a cloud reputation service for a category of a URL associated with the online transaction. Determining the sensitivity level may include querying a cloud reputation service for a reputation of a URL associated with the online transaction. the Determining the sensitivity level may include querying a cloud reputation service for a reputation of at least one of a URL, a browser extension, an application, a merchant, or a public network. Implementations of the described techniques may include hardware, a method or process, or computer software on a computer-accessible medium.

One general aspect includes one or more tangible. The nontransitory computer-readable storage media also includes identify an online transaction for an end-user device, where the online transaction is associated with data associated with a user. The media also includes compute or receive a plurality of contextual factors associated with the online transaction. The media also includes determine a sensitivity level for the online transaction according to the plurality of contextual factors. The media also includes according to the sensitivity level, specifically increase security for the online transaction without affecting security of at least one other online transaction of the end-user device. The media also includes other embodiments of this aspect include corresponding computer systems, apparatus, and computer programs recorded on one or more computer storage devices, each configured to perform the actions of the methods.

Implementations may include one or more of the following features. The one or more tangible, nontransitory computer-readable media where the sensitivity level is selected from a set of discrete sensitivity levels. One of the plurality of contextual factors is a user profile. One of the plurality of contextual factors is a task type. One of the plurality of contextual factors is an online service associated with the online transaction. One of the plurality of contextual factors is a network on which the online transaction occurs. One of the plurality of contextual factors is a device context. One of the plurality of contextual factors is a browser context. the Specifically increasing security may include disabling a key logger or screen grabber. Specifically increasing security may include adding one or more layers of authentication. Specifically increasing security may include auto-filling or clearing at least one field of a web form that calls for personally-identifying information. The at least one field is a non-mandatory field. Contextually increasing security may include hardening a web browser environment. Contextually increasing security may include enabling a VPN tunnel. The VPN tunnel is specific to a browser tab. Contextually increasing security may include handling the online transaction via a remote cloud-based browser. Determining the sensitivity level may include querying a cloud reputation service for a category of a URL associated with the online transaction. Determining the sensitivity level may include querying a cloud reputation service for a reputation of a URL associated with the online transaction. Determining the sensitivity level may include querying a cloud reputation service for a reputation of at least one of a URL, a browser extension, an application, a merchant, or a public network. Implementations of the described techniques may include hardware, a method or process, or computer software on a computer-accessible medium.

One general aspect includes a method of providing holistic transaction security on an end-user device. The method of providing holistic transaction security also includes identifying, on the end-user device, an online transaction including associated with a user. The security also includes computing or receiving a plurality of contextual factors associated with the online transaction. The security also includes determining a sensitivity level for the online transaction according to the plurality of contextual factors. The security also includes according to the sensitivity level, specifically increasing security for the online transaction without affecting security of at least one other online transaction of the end-user device. Other embodiments of this aspect include corresponding computer systems, apparatus, and computer programs recorded on one or more computer storage devices, each configured to perform the actions of the methods.

Implementations may include one or more of the following features. The method where the sensitivity level is selected from a set of discrete sensitivity levels. An apparatus may include means for performing the method. The means for performing the method may include a processor and a memory. The memory may include machine-readable instructions that, when executed, cause the apparatus to perform the method. The apparatus is a computing system. at least one computer-readable medium may include instructions that, when executed, implement a method or realize an apparatus. One of the plurality of contextual factors is a user profile. One of the plurality of contextual factors is a task type. One of the plurality of contextual factors is an online service associated with the online transaction. One of the plurality of contextual factors is a network on which the online transaction occurs. One of the plurality of contextual factors is a device context. One of the plurality of contextual factors is a browser context. Specifically increasing security may include disabling a key logger or screen grabber. Specifically increasing security may include adding one or more layers of authentication. Specifically increasing security may include auto-filling or clearing at least one field of a web form that calls for personally-identifying information. The at least one field is a non-mandatory field. Contextually increasing security may include hardening a web browser environment. Contextually increasing security may include enabling a VPN tunnel. The VPN tunnel is specific to a browser tab. Contextually increasing security may include handling the online transaction via a remote cloud-based browser. Determining the sensitivity level may include querying a cloud reputation service for a category of a URL associated with the online transaction. Determining the sensitivity level may include querying a cloud reputation service for a reputation of a URL associated with the online transaction. Determining the sensitivity level may include querying a cloud reputation service for a reputation of at least one of a URL, a browser extension, an application, a merchant, or a public network. Implementations of the described techniques may include hardware, a method or process, or computer software on a computer-accessible medium.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Contemporary computer practice may involve large numbers of sensitive transactions for users. Sensitive transactions may include financial transactions, such as online purchases, and can also include other transactions of both a monetary and nonmonetary nature. For example, a sensitive transaction can include bank transfers, stock trading, purchases of tickets, goods, or services online, private information shared over mobile or social networks, bill pay, checking a bank account balance, and many other types of transactions. When sensitive data and information are shared over social networks and other platforms, the compromise of those data can represent a serious risk to the end-user. Many users broadcast private information, including personally identifying information (PII) and other similar data, opinions, personal photos, videos, political views, and similar. On social media platforms, these may be shared with a wide digital audience, including members of the public that the original poster did not intend to include.

Sensitive transactions may span many different types of interactions that a user has online, including with cloud services. In some cases, sensitive transactions may be part of a user's workflow. In other cases, sensitive transactions are done for personal reasons, entertainment, or other reasons. A sensitive transaction may occur simply by logging into a service, in which case the login may be tracked along with the date, time, user's internet protocol (IP) address, and other information that can be used to track or identify the user. Filling a form in online can include the user sharing both sensitive and non-sensitive data. Many online forms have mandatory or required fields (e.g., fields that must be filled in for the transaction to be completed), as well as non-mandatory or optional fields. Both mandatory and non-mandatory fields may call for the user to enter PII, and depending on the user's privacy sensitivity, the user may or may not wish to share these data. In some cases, the user may opt to skip fields in an online form that are non-mandatory and that call for PII. Furthermore, even in the case of mandatory fields, some users may prefer to provide false data to limit the distribution of their PII. For example, some users may prefer to provide a false name, address, birthdate, email address, phone number, or similar to prevent leakage of PII.

Because sensitive transactions include PII, financial data, and other sensitive data, they may be of significant value to hackers and other attackers or bad actors. Misuse of sensitive transaction data can lead to financial loss, reputation damage, mental health consequences, physical safety consequences, or other negative effects. For example, financial fraud has increased greatly recently because many users are misled by false websites, phishing scams, and other similar attacks. Attackers have become more sophisticated in their efforts to acquire PII and sensitive data from users and in covering their tracks.

Some service providers have provided mechanisms to help mitigate the risk of data leakage. For example, financial institutions, social networks, and other similar platforms have implemented protections like two-factor authentication and may use AI, artificial intelligence, or machine learning (ML) techniques in fraud detection. These efforts may be effective in mitigating certain types of threats. However, it is more difficult for these protections when certain pieces of the transaction are outside of their purview, such as those things that take place in the client environment (e.g., an endpoint device). Transactions may also occur on unsafe social networks or users may be compromised via social engineering.

Thus, even strong protections by service providers may not be able to fully protect end-users. Furthermore, there may be cases where a user wishes to use a service (such as a social media site) even though that particular web service may have a negative or unfavorable reputation for privacy and security. Thus, it may be in the interest of the user to be able to use these social media sites or other sites while minimizing their potential exposure. Embodiments of the present specification provide an end-to-end protection of entire transaction flows. This may include, for example, the client endpoint device or system, a browser or app, the network the user is connected to, and the online service. Protecting transactions at each of these points can be very valuable. For example, there may be value in detecting vulnerabilities in the client operating system, browser, applications, or similar. Threats may include keyloggers, screen capture, audio and video recording malware, phishing sites, malicious extensions, malware, rogue apps, malicious or fraud sites, SMS/OTP intercepts, or similar.

It is also valuable to protect the network that the user is operating on. If a user is connected by a hard wire to her own home network, then she may be relatively protected so long as her home network is properly configured. However, if she connects via Wi-Fi, there is a possibility of a rogue Wi-Fi network hijacking the transaction. Furthermore, if she connects to a public Wi-Fi network, then she may be connecting to a network that she knows very little about. Threats on the network may include, by way of illustrative and nonlimiting example, man in the middle (MITM) attacks, rogue Wi-Fi networks, rogue DNS resolvers, and similar.

It is also valuable to protect the user from threats on online services. For example, the user may access financial services. If the user is accessing a website that provides financial services, then the user may be vulnerable to weak or no encryption, similar-looking or typo domain squatting websites that visually match the legitimate website, services with poor reputations, data mingling, darknet source leak, or other similar threats.

As in many systems, the weakest link in the chain can prove to be the most likely point of failure. If a bad actor gains access to the user's information, it may not matter so much to the user where the breach happened, so much as the fact that the breach did happen. Thus, each link in the chain, if it is not properly protected, may nullify the benefits of strong protections provided by other links in the chains. Note that the examples above are a nonexistent and illustrative list of threats that surround sensitive transactions and which may be outside of the purview of traditional protections provided by websites and/or traditional antivirus solutions. For example, strong and secure online services are unable to protect the end-user if he has a keylogger installed on his personal computer (PC) without his knowledge. Similarly, a user who is not careful with her browsing habits may not be safe from phishing or other misdirections, even if the legitimate web services she is trying to access provide strong protection.

The hardening of the present specification provides a holistic solution that protects a transaction against a plurality of threat surfaces. This may augment traditional security measures with advanced transaction-specific protection mechanisms that harden and protect the system, browser environment, and network infrastructure against malicious actors or online services. The foregoing can be used to build or embody several example implementations, according to the teachings of the present specification. Some example implementations are included here as nonlimiting illustrations of these teachings.

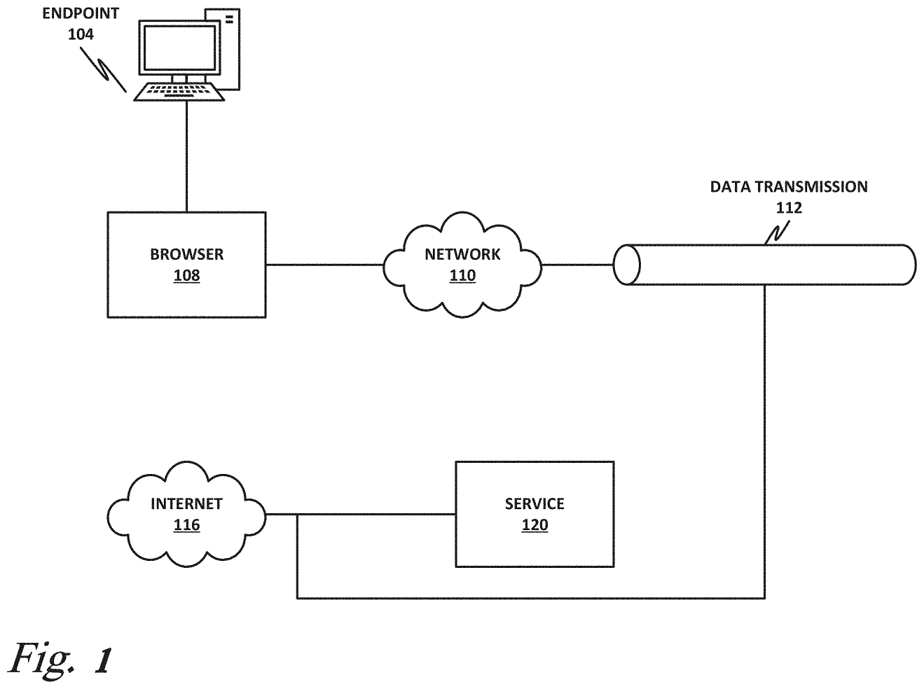

FIG. 1 is a block diagram of selected elements of a network ecosystem 100. Network ecosystem 100 includes an endpoint 104, which operates a browser 108. Via browser 108, endpoint 104 accesses a network 110. Over network 110, browser 108 provides data transmission 112 to internet 116. The user may use internet 116 to access an online service 120, such as a financial website, a social media site, a shopping site, or similar. In various transactions, any one of endpoint 104, browser 108, network 110, data transmission 112, internet 116 and/or online service 120 can represent a security vulnerability.

To mitigate the risk, the present specification provides a mechanism to identify and protect sensitive transactions holistically across a plurality of threat environments. For example, the system may analyze the transaction context, identify the sensitivity using a knowledge base and capabilities, assess the trustworthiness of a service, and provide end-to-end protection for any sensitive transactions originating from a user's machine. In providing this protection, the system may utilize new and/or existing services and technologies. For example, existing services include McAfee Inc.'s global threat intelligence (GTI), cloud access security broker (CASB), McAfee LiveSafe (MLS), Tunnel Bear VPN, a browser extension reputation service, a public network reputation service, a service trustworthiness database, web advisors, and other similar. Other vendors may provide similar or different protections.

The use of different sensitivity levels for different transactions helps provide a smooth and unintrusive experience for users as they carry out transactions. The use of selective protections can help to ensure better hardening of system resources by providing more stringent protection for more sensitive transactions, while providing more relaxed protection for less sensitive transactions. This can help to provide protection for sensitive user data without degrading system performance.

Embodiments of the present specification provide a mechanism and algorithm that can mitigate the transaction risk and ensure the safety and privacy of transactions. For purposes of discussion, components may be divided into two parts. These two parts need not necessarily be discrete devices, modules, or other discrete components but rather are disclosed here as two separate functions for convenience of discussion. The first function is identification of the sensitivity of a transaction. This can include a plurality of transaction-specific contexts. The transaction-specific contexts may include metadata about the transaction that can be used to determine how sensitive the transaction is. For example, a user context may identify who the user is, such as a user profile. This can include the user's age, gender, profession, or other contextual information that may help to identify the user's susceptibility to certain types of attacks, and, in particular, social engineering attacks. A job context may include information about what the user is trying to accomplish with the transaction, such as a task type. A service context could include the service that the user is accessing, such as an online or cloud-based service.

A network context may include information about which network the user is connected to (e.g., network 110) and reputation information about the network, information about the network's DNS configuration, whether the user has a VPN, or similar. This may also include whether the network is secure or unsecured and whether the user has indicated that the network is trusted. A location context may include information about the user's physical location, which may be provided, for example, by location services on endpoint 104. A system or device context may contain information about endpoint 104. For example, is endpoint 104 a shared device or is it a device that only one user generally operates? Does endpoint 104 have security software installed, such as a traditional antivirus agent? What other protections are provided on endpoint 104? A browser context may include information about browser 108, such as the name and version number of the browser used, extensions installed, security settings of the browser, and similar. A data context may include information about the data being transmitted, 112, such as the sensitivity of the data, the source of the data, and the destination of the data.

A transaction protection orchestrator uses the transaction context to make decisions about how to protect the device or to protect the transaction. This may include automatic hardening or management of the environment based on the sensitivity of the transaction. This may combine existing solutions, such as antivirus and firewall, which may be complemented with additional protection capabilities. For example, the protection orchestrator may automatically turn off keyboards or keyboard loggers or screen grabbers. It may introduce additional layers of authorization and/or authentication for accessing system resources. It may autofill and/or clear certain non-mandatory fields, and, in particular, may identify non-mandatory fields that call for PII data. In some cases, the protection orchestrator may fill online fields that call for PII data with false data if it is contextually useful to do so. For example, in some cases, a phone number or email address may need to be used for account verification. In that case, it may be necessary to provide a legitimate phone number or email address. If a product is to be shipped to a home address, then a correct home address may be necessary. If a credit card is being used, then a correct ZIP Code may be necessary. However, in some cases, not all of these need to be provided in every instance. Thus, in those cases, false or auto-generated misinformation may be provided to the online field.

The protection orchestrator may also harden the browser environment. For example, the protection orchestrator may contextually disable certain browser extensions that are not necessary for a particular transaction. In an example, if a user is accessing a banking website, it is unlikely that the user needs a grammar-checking extension like Grammarly or similar. While this extension may be very valuable in the context of a social media post or an email communication, in the context of a banking transaction, it is more likely to simply be a potential security aperture. Thus, a grammar-checking extension that requires a high level of access may be disabled when the user is visiting a banking website.

In another example, the protection orchestrator may automatically turn on a system VPN, or alternately, may provide a tab-specific VPN to tunnel only certain transactions. For example, if the user is performing a financial transaction, and if the user's system-wide VPN is not used, then a lightweight VPN may be provided to tunnel only traffic for that specific browser tab that the user is operating to perform the banking transaction.

In another example, the protection orchestrator may determine the trustworthiness of online services and warn the user of services with poor reputations or recommend a service that provides a similar service but that has a better reputation. For example, if a service is known to be prone to massive data leaks, then the user may receive a recommendation to visit a different service that is similar but has a better reputation for data protection.

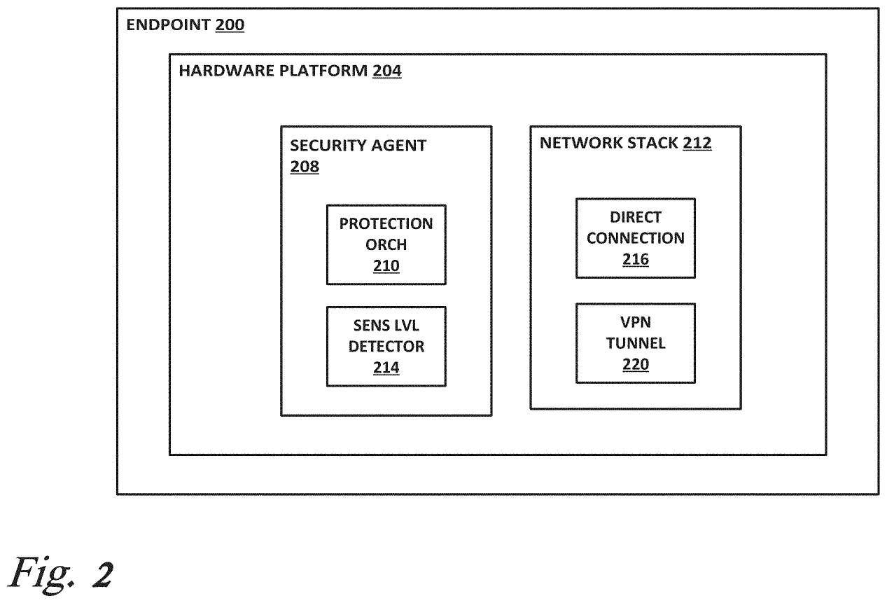

FIG. 2 is a block diagram of selected elements of an endpoint device 200. Endpoint 200 is an input device that a user may use to access services and to perform certain sensitive transactions.

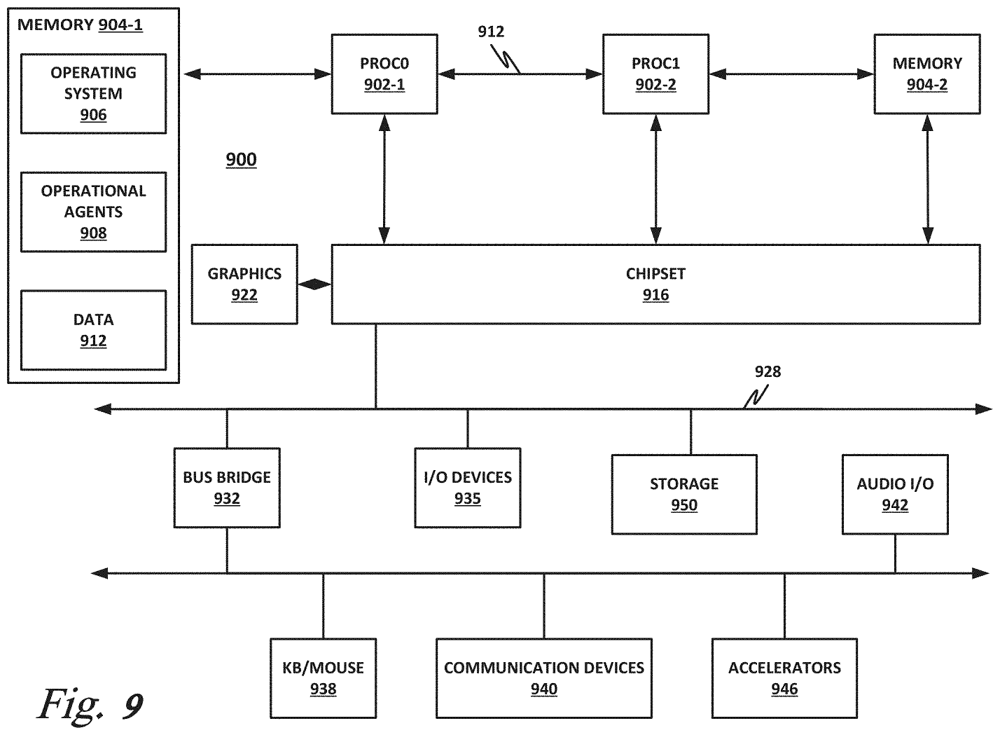

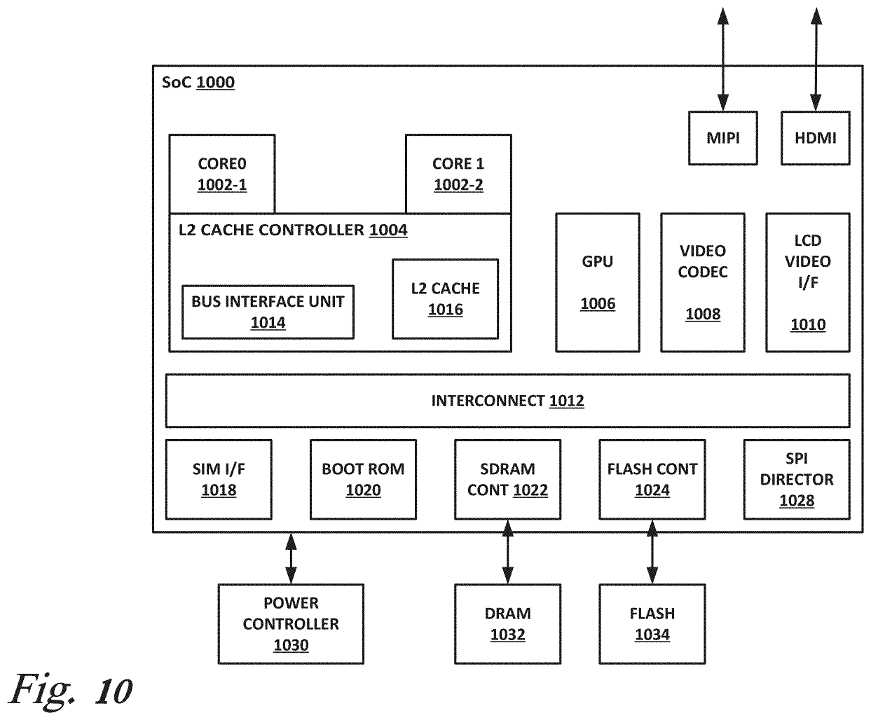

Endpoint 200 includes a hardware platform 204. Hardware platform 204 may be any suitable hardware platform, such as those disclosed in FIGS. 9 and 10 below.

Hardware platform 204 may in particular include a processor and/or a memory. The processor may be programmable to perform certain functions, and the memory may have stored therein certain executable instructions that may be used to program the processor.

Endpoint 200 may include a security agent 208. Security agent 208 may include traditional security functions, such as antivirus, anti-malware, a VPN, one or more reputation services, and other security features. For example, McAfee Inc. provides a product called McAfee Total Protection that acts as a security agent.

A protection orchestrator 210 may, in some cases, be a submodule or part of security agent 208. In other cases, protection orchestrator 210 may be a separate module and may even be provided by a separate vendor. Protection orchestrator 210 may include executable instructions to carry out algorithms consistent with the teachings of the present specification. For example, when protection orchestrator 210 is to be used, a processor of hardware platform 204 may load executable instructions from the memory and then sequentially execute those instructions to perform the algorithm. Protection orchestrator 210 may be configured to selectively harden certain aspects of a transaction according to the contextual inputs thereof.

A sensitivity level detector 214 may also be a part of security agent 208. Sensitivity level detector 214 may also optionally be a separate module and could be separate from protection orchestrator 210, including being a product from a separate vendor.

Protection orchestrator 210 and sensitivity level detector 214 together may provide a useful algorithm for performing a holistic hardening of a sensitive transaction. For example, protection orchestrator 210 may examine the context of a transaction and assign an overall sensitivity level to the transaction. In some cases, this is a discrete level selected from among a plurality of available discrete levels. For example, levels may include an integer or a color coding such as “red,” “yellow,” or “green.” Other identifiers could be used for sensitivity levels.

Once sensitivity level detector 214 has assigned a sensitivity level to a transaction, protection orchestrator 210 may perform certain hardening actions. This may include, by way of illustrative and nonlimiting example, managing installed browser extensions, browser environment hardening, providing privacy recommendations based on a merchant service reputation, auto-filling of a form, avoiding non-mandatory PII info in a form, turning on VPN, providing a tab-specific VPN based on context, performing browser database protection, performing controlled access to data structures, detection of keyloggers or other keygrabbers that may be logging browser keystrokes, detection of tools that may be performing screen scraping or video recording, or otherwise detecting and/or disabling adverse software.

Endpoint 200 may also include a network stack 212. This could be, for example, a seven-layer network stack according to the TCP/IP and/or OSI network stack models. Network stack 212 may provide both a direct connection 216 as well as a VPN tunnel 220. As described above, the direct connection 216 may be suitable for some transactions while VPN tunnel 220 may be preferable for other transactions.

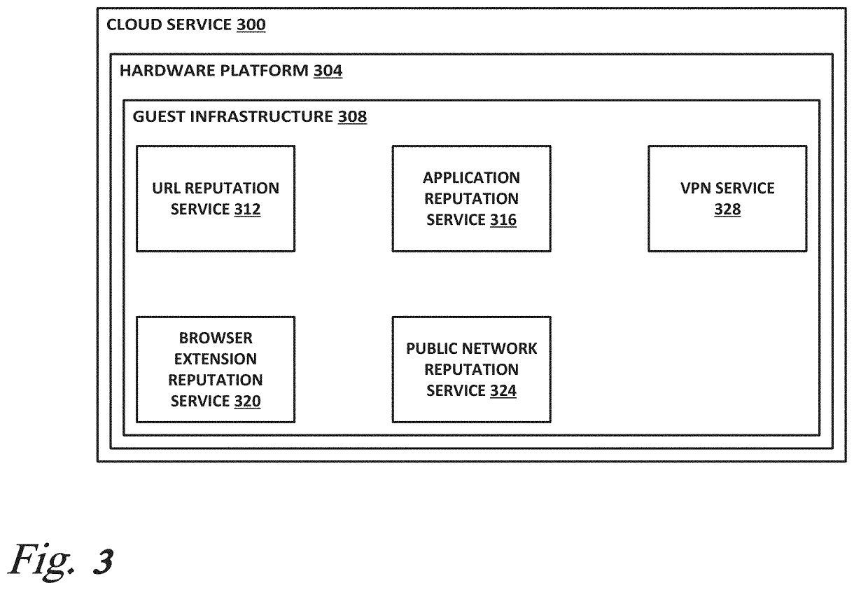

FIG. 3 is a block diagram of selected elements of a cloud service 300. Cloud service 300 may be operated by a suitable provider, such as a security services provider or by one or more vendors. Cloud service 300 provides various services over a network.

In this example, cloud service 300 provides a hardware platform or hardware platforms 304. Hardware platform 304 could be a single server or could be an array of distributed machines across a variety of geographic locations and/or different enterprises. For example, hardware platform 304 could be hosted in a data center, multiple data centers, on a rackscale architecture, on a mainframe, on some other suitable computing device, or high-performance computer (HPC).

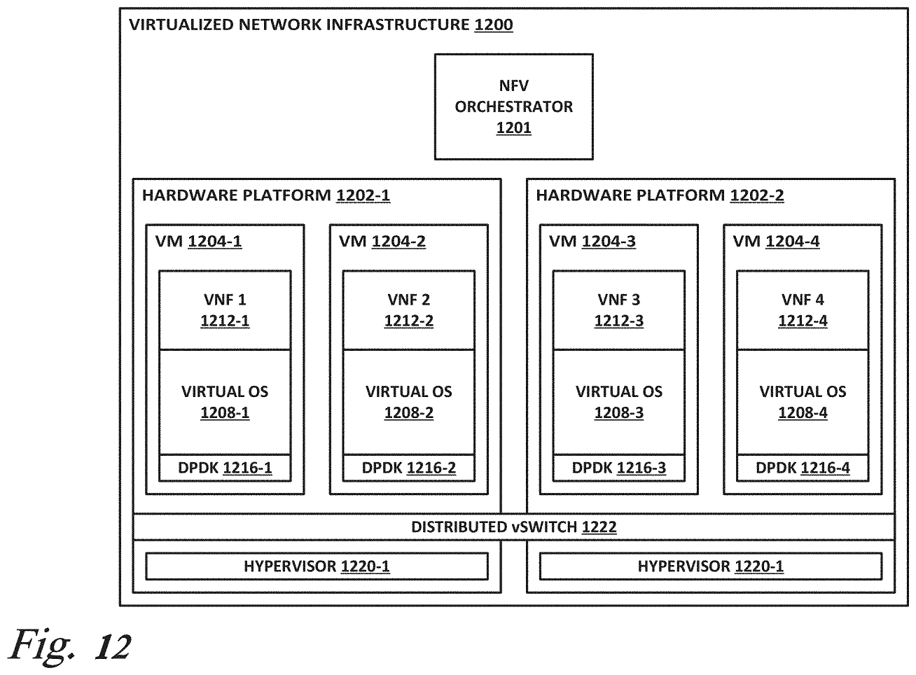

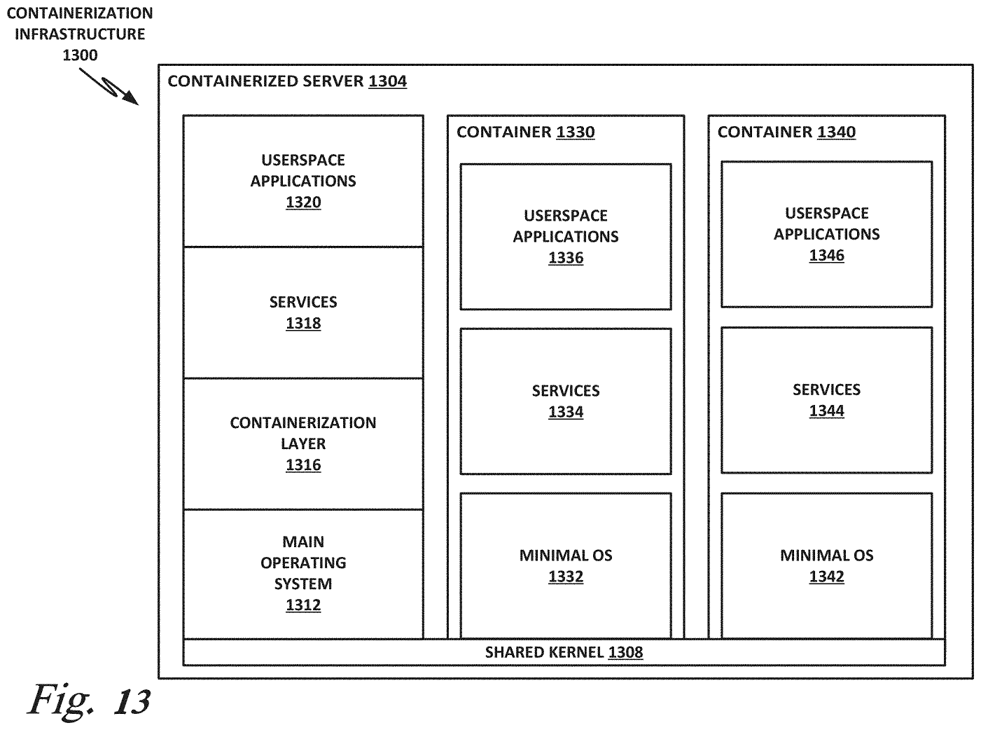

Hardware platform 304 may optionally provide a guest infrastructure 308. Guest infrastructure 308 may provide suitable APIs, hardware, interfaces, and other infrastructure for guest environments, such as virtualization, containerization, snaps, or similar. Examples of virtualization and containerization are provided in FIGS. 12 and 13 below.

Several services may run on guest infrastructure 308, such as in different virtual machines, different containers, different snaps, or in some other suitable guest service. These can include, by way of illustrative and nonlimiting example, a URL reputation service 312, an application reputation service 316, a browser extension reputation service 320, a public network reputation service 324, and a VPN service 328. Other services could also be provided as appropriate to an embodiment.

In an example, URL reputation service 312 may provide reputations for URLs that a user or endpoint device visits. For example, McAfee's GTI service provides such a service. URL reputation service may provide, in addition to a reputation, other metadata about a URL. For example, it could include a category or type for the URL, a threat level, information about the operator, or other similar data that may be useful for helping to make decisions about the context of a URL that the user visits via the endpoint device.

Application reputation service 316 may provide similar metadata about applications that the user may be running. This could include, for example, information about whether applications have been determined to be malware, whether they collect unnecessary permissions, whether they are believed or known to collect and share user data, whether they perform audio or video recording, or screen scraping, or similar.

Browser extension reputation service 320 may provide similar metadata about browser extensions. For example, this could include information about whether a browser extension is malicious, what types of data it collects, and categories of websites for which it may be appropriate or inappropriate. For example, a grammar-checking extension may be suitable for a social media posting website or similar but may be unsuitable and unnecessary for an e-commerce or banking website.

Public network reputation service 324 may provide similar metadata and reputations for publicly accessible networks, and especially Wi-Fi networks. This may include whether a network is prone to security vulnerabilities, whether it's encrypted, whether it provides adequate user protection, whether it is known or believed to collect information about users who connect to the network, and whether the network has been breached in the past.

VPN service 328 may be provided to operate a virtual private network that encrypts communications and that a user can connect to. A VPN is particularly useful in the case where a user connects to a public network such as the Wi-Fi network that is unencrypted, and thus the user's data may be exposed. Furthermore, when connecting to such a network, the network operator can collect information about the user such as the websites that the user visits and data that are exchanged. In some cases, if an HTTP connection is provided instead of an HTTPS connection, then the operator or a bad actor could snoop on network traffic and extract the user's data. Thus, VPN service 328 may be provided so that the user has a secure end-to-end connection that cannot be snooped even if the user visits an unencrypted website via the VPN service. Optionally, certain browser tabs may be routed through the VPN if they are contextually determined to be sensitive and optionally based on a reputation of the note that the user is connected to. For example, if the user is connected to her home network, then she may be relatively safe so long as she is legitimately connected to the home network and not to a spoofed or malicious Wi-Fi hotspot. However, if she connects in a coffee shop over an unencrypted network, then her data may be more exposed.

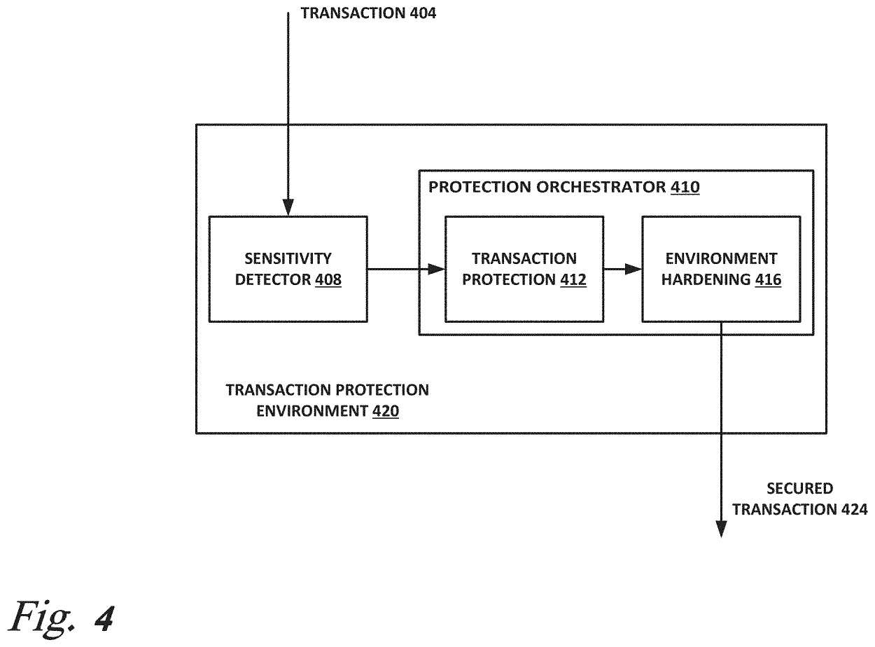

FIG. 4 is a block diagram of selected elements of a transaction protection environment 420. Transaction protection environment 420 may include the two aspects of the disclosure identified earlier, namely a sensitivity detector 408 and a protection orchestrator 410. As discussed above, these need not be separate or discrete elements but could be provided in a single element or even across different devices.

Sensitivity detector 408 provides a mechanism that can determine the user's job context and derive the sensitivity of the transaction. Protection orchestrator 410 can then provide a multilayered protection environment to ensure the security, integrity, and privacy of the user during the transaction process. The holistic security can be provided across multiple threat surfaces, including the device, the browser, the network, and the online service.

Transaction protection environment 420 receives an incoming transaction 404 as an input and provides a secured transaction 424 as its output.

The incoming transaction 404 is first handled by sensitivity detector 408. Sensitivity detector 408 may provide a context and sensitivity detection engine to determine the sensitivity level of, for example, a visited webpage which provides the transaction site. In some examples, sensitivity detector 408 may operate on a plurality of context inputs.

For example, a host URL category may affect the context sensitivity. The category and subcategory of an access domain may be derived using a URL reputation service. Some categories and subcategories are inherently sensitive. For example, business, finance or banking, or healthcare websites may be deemed inherently sensitive. On the other hand, sites, such as news websites or other URLs that are intended primarily for consumption and not creation or sharing of data, may be less sensitive.

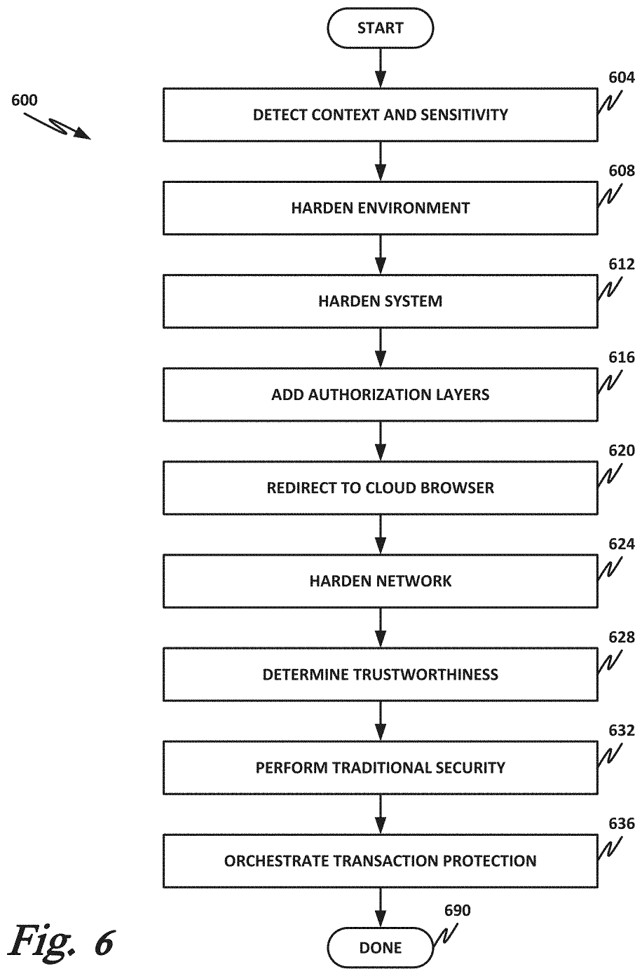

Sensitivity detector 408 may assign, in some cases, a discrete sensitivity level to a transaction. This provides an input to protection orchestrator 410. Protection orchestrator 410 may provide a plurality of transaction protection components 412. A number of illustrative transaction protections are provided in FIG. 6 below. This should be understood to be a non-exhaustive and illustrative list of protections that may be provided to a transaction.

Protection orchestrator 410 also includes an environment hardening engine 416. Environment hardening engine 416 may be responsible for actually carrying out certain protections as directed by protection orchestrator 410. Once the environmental hardening has been carried out, a secured transaction 424 is provided.

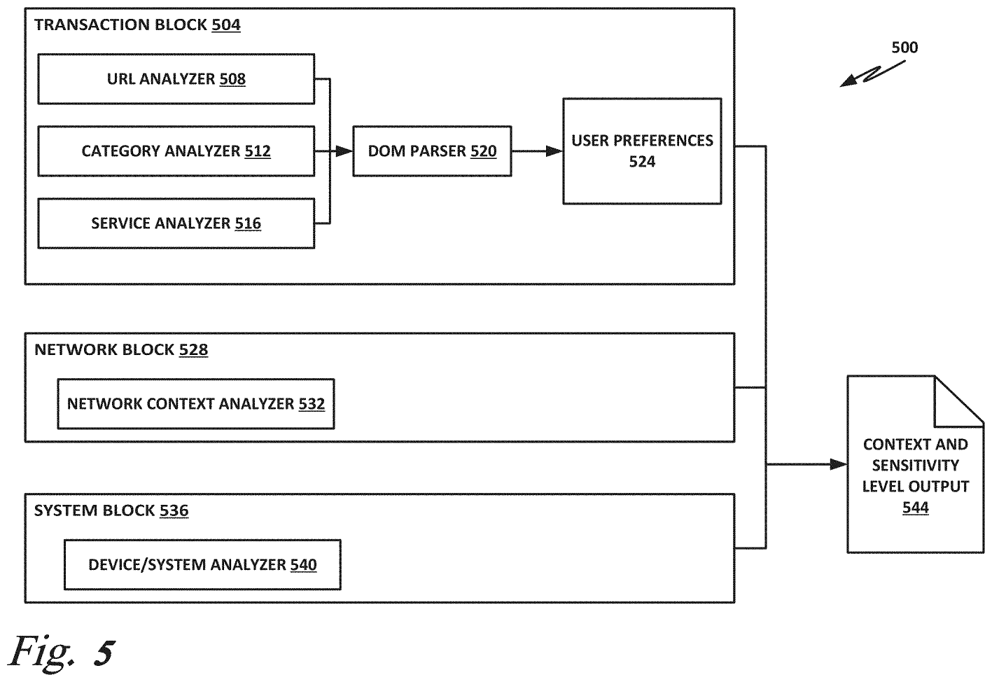

FIG. 5 is a block diagram of selected elements of a sensitivity detector 500. Sensitivity detector 500 may be, in some cases, an instance of sensitivity detector 408 of FIG. 4 or could be a different sensitivity detector.

Sensitivity detector 500 may interact with various cloud-based services, such as one or more reputation services, a crowdsourced URL repository, or any other data source that helps sensitivity detector 500 to make appropriate decisions. In this illustration, sensitivity detector 500 is divided into a transaction block 504, a network block 528, and a system block 536. These are provided by way of illustrative example only and need not be discrete or separate elements.

URL analyzer 508 may perform a regular expression or other analysis of a visited URL. This can help to establish the sensitivity of a page. For example, if the URL contains words like login, set up, registration, payment, or similar keywords, this may indicate that sensitive pages have been provided to the end-user. It may be determined via URL analysis that these pages relate to account creation, access, and/or payments.

Service analyzer 516 may analyze the services provided by a website, such as by extracting HTML or JavaScript code, analyzing images, performing similarity analysis (e.g., such as comparing the website to known websites to determine typo squatting), or performing similar analysis of the service.

URL analyzer 508, category analyzer 512, and service analyzer 516 may provide inputs to DOM parser 520. DOM parser 520 may perform DOM walk-through and scraping for label analysis, filled or element analysis, or similar. DOM parser 520 may use a variety of DOM scraping techniques to scan for sensitive fields on a visited page. DOM parser 520 may identify tags and web elements on a webpage along with their fill tag, associated labels, and other data that indicate whether a page contains or collects any sensitive data. For example, a webpage with a credit card edit box may be deemed sensitive as may be a webpage with a username and/or password fill. DOM scraping may be used to establish the sensitivity of a webpage and may be further enhanced by applying ML and/or AI techniques.

The inputs from this block can be combined with user preferences 524 to provide an overall transaction context.

In some embodiments, URL reputations may be enhanced or supplemented by a repository of manual URL reputations. This can include a repository of sensitive URLs as determined by manual inspection and testing and the use of URL lookups to decide if a page is sensitive or not.

Sensitive pages may also be supplemented through crowdsourcing. For example, crowdsourcing may be used to create a repository of sensitive pages that use a URL lookup to determine if a page is sensitive or not. When users visit a page, they may be given an option to tag it is either being sensitive or not sensitive, as the case may be.

Within network block 528, a network context analyzer 532 may be used to determine the sensitivity of the network. For example, network context analyzer 532 may determine whether the network is secured or unsecured, whether it is a home or trusted network, and may optionally receive a reputation for a public network, such as a public Wi-Fi network. The network context analyzer 532 may then be used to influence the sensitivity of a transaction.

Within system block 536, device or system analyzer 540 may inspect various data about the system itself. This can include the operating system and version, the security features of the operating system, the browser being used and its security features, and other apps that are being used at the time.

The output of sensitivity detector 500 is a context and sensitivity level output 544. As described above, this could be an output on a discrete scale.

Within transaction block 504, a category analyzer 512 may determine the host category of the URL, such as by using a URL reputation service. As described above, some URL categories may be inherently more sensitive than others.

FIG. 6 is a flowchart of a method 600. Method 600 may be performed according to the teachings of the specification, such as by a sensitivity level detector and a protection orchestrator working together. Other combinations and embodiments are also contemplated.

In block 604, the system may detect the context and sensitivity of a particular transaction, such as according to a sensitivity detector. Sensitivity detector 500 of FIG. 5 provides a detailed description of such a sensitivity detector.

Once a sensitivity level has been determined, then in blocks 608 through 636, a protection orchestrator such as protection orchestrator 410 of FIG. 4 may carry out the hardening of the transaction. This may be a holistic hardening that protects the transaction at various points.

In block 608, a client environment hardener may harden the client environment. This may include, for example, browser environment hardening. In one example, browser environment hardening includes automatic management of extensions. One or more extensions may be automatically disabled if they have a poor reputation for security or if they have a reputation for being inappropriate or dangerous to a sensitive transaction. This automatic disabling may be in context, such as only in a certain tab and only while a sense of transaction is being performed.

One part of this may include the use of an extension reputation cloud service. This contextual extension management may be provided by disabling extension whose reputation is below a threshold for that type of transaction. This helps to harden the browser environment by disabling suspicious extensions on sensitive websites, such as banking sites, payment sites, trading sites, and similar. On the sensitive website, inappropriate browser extensions may be disabled, which mitigates the risk associated with those browser extensions. On non-sensitive websites, these extensions may be enabled to provide the user the experience and/or utility that he derives from those extensions. The enabling and disabling of extensions on non-sensitive and sensitive websites automatically removes from the user the need to manually perform extension management when visiting sensitive websites.

Another aspect of environment hardening may include advanced phishing protection. For example, an analysis of visually similar webpages may be used to automatically identify and block sites that may be masquerading as a legitimate site. The user may also be warned of the invalid sites. This can help protect the user, for example, from clicking on a link that appears to be from the user's bank but is actually a phishing website. Environment hardening may also include automatically enabling or disabling certain trackers, performing picky cleanup, performing history of bookmark protection, or otherwise segregating the user-sensitive data.

In block 612, the orchestrator performs system hardening. System hardening may include, for example, enabling a virtual keyboard provided by a security services provider. This security keyboard may be known to have security features and may be used to protect the user's privacy and security during sensitive transactions. This can supplant other software keyboards that may be used on other websites and may not provide the same protections.

System hardening may also include detecting Remote Desktop apps and restricting screen capture tools. In some cases, during sensitive transactions, only certain allowed applications may be permitted to run or to operate in the background. Other applications may be suspended as necessary.

Another aspect of system or environment hardening may include an application reputation or rogue app detection. This can include app fingerprinting or hashing to detect malicious applications. This can be used in one example to protect against overlay attacks.

In block 616, the orchestrator may add extra layers of authorization. Adding extra layers of authorization or authentication to a browser database or other hardware sensor light cameras or microphones may enhance the user's protection.

A browser database may typically be encrypted with the user login session key. Any application on the system can thus easily decrypt the content. The orchestrator disclosed herein provides an extra layer of authentication to ensure that only the browser process has access to this database and no other process can access it.

Based on the type of applications installed and running on the system, and optionally including the reputations of those apps, the orchestrator may also add a layer of authentication and authorization to apps requesting hardware or sensor access on the device.

In block 620, the system may redirect certain sensitive transactions via a cloud browser. The cloud browser may be a security-enhanced browser that is provided by a cloud service. When the user is on a sensitive website, a so-called browser within a browser can then be launched in a particular tab. By redirecting the user's browser session to a cloud-based browser running a secured sandboxed environment, client-side threats can be mitigated.

In block 624, the orchestrator may harden the network. For example, the orchestrator may enable a system-level VPN or a browser level tab-specific tunneling VPN. An extra layer of security and privacy is added to certain sensitive operations by contextually auto-enabling the system VPN or a browser proxy VPN for a specific domain. Once the session is over or the tab containing the sensitive transaction is closed, the VPN tunnel may be automatically terminated. Optionally, security may also be enhanced by enabling a secure DNS protocol, such as DNS over HTTPS or DNS over TLS. This can be done for all transactions or for certain transactions that are deemed to be sensitive.

In block 628, the orchestrator may determine trustworthiness. This can include the trustworthiness of cloud services that user is accessing and may be in addition to a URL host reputation. The trustworthiness of a service may be derived using a plurality of parameters across a plurality of categories. These may include:
a. Data risk: how data are protected in rest, in motion, and during use;
b. User/device risk: what device level protections are provided (e.g., such as two-factor authentication);
c. Service risk: how well the service is protected against attacks;
d. Business risk: where the data are stored and where business is carried out;
e. Legal risk: how intellectual property and copyrights are treated by the platform;
f. Cyber risk: how the service fares against known vulnerabilities.

For example, the system may utilize certain existing technologies such as SkyHigh and CASB registry scores to arrive at a trustworthiness score for an online service. The scores for these parameters are used along with the context and sensitivity of the transaction to provide recommendations to the user, such as recommending caution about the risk associated with performing transactions on a cloud service.

In block 632, the orchestrator may perform traditional security. For example, in addition to the protections described above, traditional security and privacy protections may be running, such as antivirus (with behavioral detection capabilities), firewalls, host reputations, and phishing protection. Different transaction protection modules may provide security throughout a transaction flow. Once a sensitive transaction is detected or initiated, all of the guards may be automatically enabled or selected guards may be automatically enabled as appropriate to the case. This helps to protect the transaction from different attacks.

In block 636, the orchestrator orchestrates the transaction protection security and privacy features. As described above, the system disclosed herein uses a number of security and privacy features to protect sensitive transactions. The system may use client-side protection features and backend services, such as reputation services, to provide end-to-end protection.

With many components working in unison, the system may still present protection results, warnings, and suggestions to the user in a way that is not overwhelming or that does not under-communicate necessary information. To do this, the system may use an algorithm that brings the best protection actions and suggestions. The algorithm may consider the severity of the transaction and match it with the security and privacy needs of the transaction. The final action may be derived from the security and privacy results from various complements.

Various protection factors may be used as so-called “control knobs” as inputs to the algorithm to determine which data to provide to the user. This can include, for example, URL category and reputation, installed extension reputations, network reputation, contextual VPN status, and trustworthiness of the service.

In block 690, the method is done.

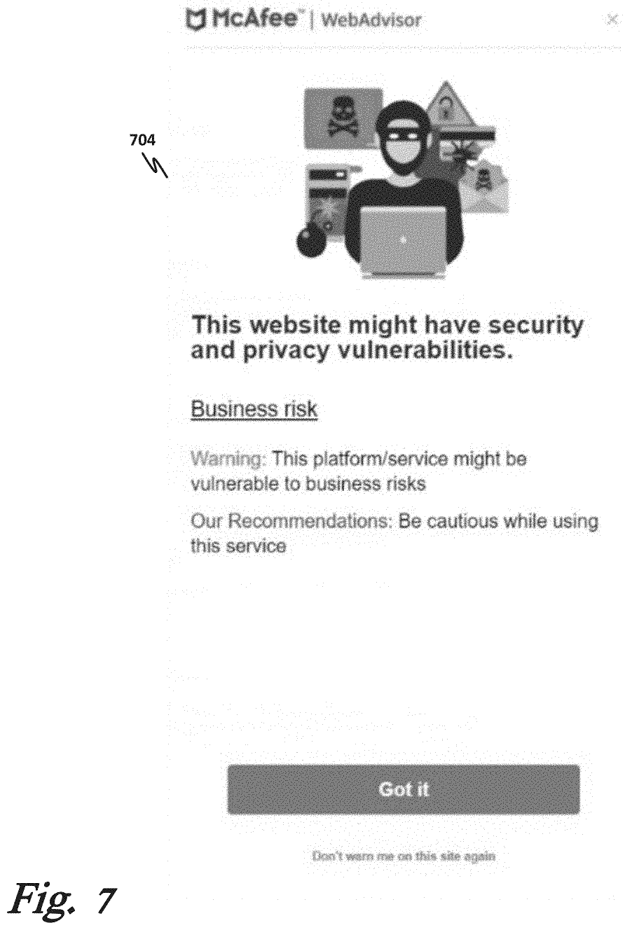

FIG. 7 is an example of a user interface element 704. User interface element 704 provides an illustrative warning that a particular website might have security and privacy vulnerabilities. In particular, this website may provide business risk, such as by leaking sensitive business data. The interface also provides a recommendation to be cautious while using the service. This interface element also gives the user an option to not receive further warnings for this site.

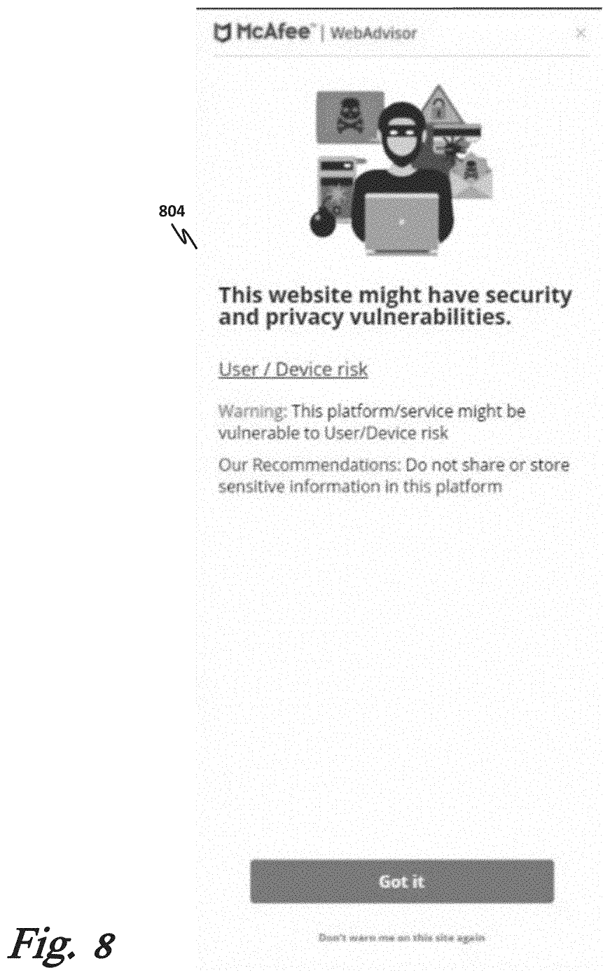

FIG. 8 is an illustration of a UI element 804. UI element 804 is for a different website that provides user or device risk. This platform or service might be vulnerable to leaking user or device information. The recommendation provided is to not share or store sensitive information on the platform. This interface element also gives the user an option to not receive further warnings for this site.

FIG. 9 is a block diagram of a hardware platform 900. A hardware platform may be used to embody any of the devices disclosed herein, including server-class or endpoint devices.

Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 900, even though they may be scattered across a data center, or even located in different data centers.

Hardware platform 900 is configured to provide a computing device. In various embodiments, a “computing device” may be or comprise, by way of nonlimiting example, a computer, workstation, server, mainframe, virtual machine (whether emulated or on a “bare metal” hypervisor), network appliance, container, IoT device, HPC environment, a data center, a communications service provider infrastructure (e.g., one or more portions of an Evolved Packet Core), an in memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 900 is arranged in a point-to-point (PtP) configuration. This PtP configuration is popular for PC and server-type devices, although it is not so limited, and any other bus type may be used.

Hardware platform 900 is an example of a platform that may be used to implement embodiments of the teachings of this specification. For example, instructions could be stored in storage 950. Instructions could also be transmitted to the hardware platform in an ethereal form, such as via a network interface, or retrieved from another source via any suitable interconnect. Once received (from any source), the instructions may be loaded into memory 904, and may then be executed by one or more processor 902 to provide elements such as an operating system 906, operational agents 908, or data 912.

Hardware platform 900 may include several processors 902. For simplicity and clarity, only processors PROC0 902-1 and PROC1 902-2 are shown. Additional processors (such as 2, 4, 8, 16, 24, 32, 64, or 128 processors) may be provided as necessary, while in other embodiments, only one processor may be provided. Details of processors 902 are not illustrated in this FIGURE, but one embodiment is illustrated in FIGURE QD. Processors may have any number of cores, such as 1, 2, 4, 8, 16, 24, 32, 64, or 128 cores.

Processors 902 may be any type of processor and may communicatively couple to chipset 916 via, for example, PtP interfaces. Chipset 916 may also exchange data with other elements, such as a high-performance graphics adapter 922. In alternative embodiments, any or all of the PtP links illustrated in FIG. 9 could be implemented as any type of bus, or other configuration rather than a PtP link. In various embodiments, chipset 916 may reside on the same die or package as a processor 902 or on one or more different dies or packages. Each chipset may support any suitable number of processors 902. A chipset 916 (which may be a chipset, uncore, Northbridge, Southbridge, or other suitable logic and circuitry) may also include one or more controllers to couple other components to one or more CPUs.

Two memories, 904-1 and 904-2 are shown, connected to PROC0 902-1 and PROC1 902-2, respectively. As an example, each processor is shown connected to its memory in a direct memory access (DMA) configuration, though other memory architectures are possible, including ones in which memory 904 communicates with a processor 902 via a bus. For example, some memories may be connected via a system bus, or in a data center, memory may be accessible in a remote DMA (RDMA) configuration.

Memory 904 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 904 may be used for short, medium, and/or long-term storage. Memory 904 may store any suitable data or information utilized by platform logic. In some embodiments, memory 904 may also comprise storage for instructions that may be executed by the cores of processors 902 or other processing elements (e.g., logic resident on chipsets 916) to provide functionality.

In certain embodiments, memory 904 may comprise a relatively low-latency volatile main memory, while storage 950 may comprise a relatively higher-latency nonvolatile memory. However, memory 904 and storage 950 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 904 and storage 950, for example, in a single physical memory device, and in other cases, memory 904 and/or storage 950 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 922 may be configured to provide a human-readable visual output, such as a command-line interface (CLI) or graphical desktop such as Microsoft Windows, Apple OSX desktop, or a Unix/Linux X Window System-based desktop. Graphics adapter 922 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 922 may include a hardware graphics card, which may have its own memory and its own graphics processing unit (GPU).

Chipset 916 may be in communication with a bus 928 via an interface circuit. Bus 928 may have one or more devices that communicate over it, such as a bus bridge 932, I/O devices 935, accelerators 946, communication devices 940, and a keyboard and/or mouse 938, by way of nonlimiting example. In general terms, the elements of hardware platform 900 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 940 can broadly include any communication not covered by a network interface and the various I/O devices described herein. This may include, for example, various universal serial bus (USB), FireWire, Lightning, or other serial or parallel devices that provide communications.

I/O Devices 935 may be configured to interface with any auxiliary device that connects to hardware platform 900 but that is not necessarily a part of the core architecture of hardware platform 900. A peripheral may be operable to provide extended functionality to hardware platform 900, and may or may not be wholly dependent on hardware platform 900. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

In one example, audio I/O 942 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 932 may be in communication with other devices such as a keyboard/mouse 938 (or other input devices such as a touch screen, trackball, etc.), communication devices 940 (such as modems, network interface devices, peripheral interfaces such as PCI or PCIe, or other types of communication devices that may communicate through a network), audio I/O 942, a data storage device 944, and/or accelerators 946. In alternative embodiments, any portions of the bus architectures could be implemented with one or more PtP links.

Operating system 906 may be, for example, Microsoft Windows, Linux, UNIX, Mac OS X, iOS, MS-DOS, or an embedded or real-time operating system (including embedded or real-time flavors of the foregoing). In some embodiments, a hardware platform 900 may function as a host platform for one or more guest systems that invoke application (e.g., operational agents 908).

Operational agents 908 may include one or more computing engines that may include one or more nontransitory computer-readable mediums having stored thereon executable instructions operable to instruct a processor to provide operational functions. At an appropriate time, such as upon booting hardware platform 900 or upon a command from operating system 906 or a user or security administrator, a processor 902 may retrieve a copy of the operational agent (or software portions thereof) from storage 950 and load it into memory 904. Processor 902 may then iteratively execute the instructions of operational agents 908 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high level language such as OpenCL, FORTRAN, C, C++, JAVA, or HTML. These may be used with any compatible operating systems or operating environments. Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 900 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fiber Channel, InfiniBand, Wi-Fi, or other suitable standard. Intel Omni-Path Architecture (OPA), TrueScale, Ultra Path Interconnect (UPI) (formerly called QPI or KTI), FibreChannel, Ethernet, FibreChannel over Ethernet (FCoE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), VPN, intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 900 may be virtualized, in particular the processor(s) and memory. For example, a virtualized environment may run on OS 906, or OS 906 could be replaced with a hypervisor or virtual machine manager. In this configuration, a virtual machine running on hardware platform 900 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 9 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. An example of such an embodiment is provided in FIG. 10. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

FIG. 10 is a block diagram illustrating selected elements of an example SoC 1000, which provides an alternative embodiment of a hardware platform. At least some of the teachings of the present specification may be embodied on an SoC 1000, or may be paired with an SoC 1000. SoC 1000 may include, or may be paired with, an advanced reduced instruction set computer machine (ARM) component. For example, SoC 1000 may include or be paired with any ARM core, such as A-9, A-15, or similar. This architecture represents a hardware platform that may be useful in devices such as tablets and smartphones, by way of illustrative example, including Android phones or tablets, iPhone (of any version), iPad, Google Nexus, Microsoft Surface. SoC 1000 could also be integrated into, for example, a PC, server, video processing components, laptop computer, notebook computer, netbook, or touch-enabled device.

As with hardware platform 900 above, SoC 1000 may include multiple cores 1002-1 and 1002-2. In this illustrative example, SoC 1000 also includes an L2 cache control 1004, a GPU 1006, a video codec 1008, a liquid crystal display (LCD) I/F 1010 and an interconnect 1012. L2 cache control 1004 can include a bus interface unit 1014, a L2 cache 1016. Liquid crystal display (LCD) I/F 1010 may be associated with mobile industry processor interface (MIPI)/HDMI links that couple to an LCD.

SoC 1000 may also include a subscriber identity module (SIM) I/F 1018, a boot ROM 1020, a synchronous dynamic random-access memory (SDRAM) controller 1022, a flash controller 1024, a serial peripheral interface (SPI) director 1028, a suitable power control 1030, a dynamic RAM (DRAM) 1032, and flash 1034. In addition, one or more embodiments include one or more communication capabilities, interfaces, and features such as instances of Bluetooth, a 3G modem, a global positioning system (GPS), and an 802.11 Wi-Fi.

Designers of integrated circuits such as SoC 1000 (or other integrated circuits) may use intellectual property (IP) blocks to simplify system design. An IP block is a modular, self-contained hardware block that can be easily integrated into the design. Because the IP block is modular and self-contained, the integrated circuit (IC) designer need only “drop in” the IP block to use the functionality of the IP block. The system designer can then make the appropriate connections to inputs and outputs.

IP blocks are often “black boxes.” In other words, the system integrator using the IP block may not know, and need not know, the specific implementation details of the IP block. Indeed, IP blocks may be provided as proprietary third-party units, with no insight into the design of the IP block by the system integrator.

For example, a system integrator designing an SoC for a smart phone may use IP blocks in addition to the processor core, such as a memory controller, a nonvolatile memory (NVM) controller, Wi-Fi, Bluetooth, GPS, a fourth or fifth-generation network (4G or 5G), an audio processor, a video processor, an image processor, a graphics engine, a GPU engine, a security controller, and many other IP blocks. In many cases, each of these IP blocks has its own embedded microcontroller.

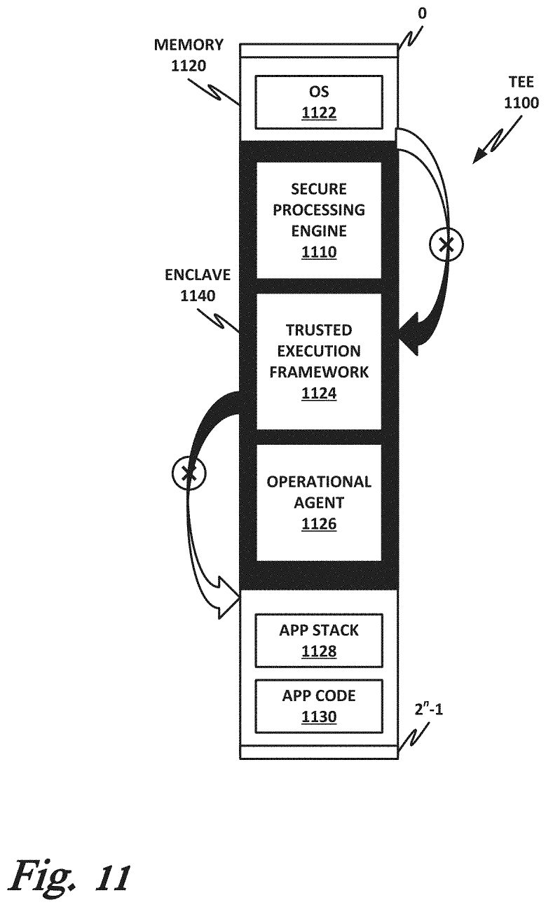

FIG. 11 is a block diagram of a TEE 1100. A TEE may be used to secure certain types of sensitive transactions, such as by providing a trusted platform module (TPM), or by providing validation of a transaction, such as via direct anonymous attestation (DAA) or some other similar attestation.

In the example of FIG. 11, memory 1120 is addressable by n-bits, ranging in address from 0 to 2ⁿ−1 (note, however, that in many cases, the size of the address space may far exceed the actual memory available). Within memory 1120 is an OS 1122, enclave 1140, application stack 1120, and application code 1130. An operational agent 1126 may include operations within a trusted compute base (TCB) that can be used to carry out features of securing a transaction according to the teachings of this specification.

In this example, enclave 1140 is a specially-designated portion of memory 1120 that cannot be entered into or exited from except via special instructions, such as Intel Software Guard Extensions (SGX) or similar. Enclave 1140 is provided as an example of a secure environment which, in conjunction with a secure processing engine 1110, forms a TEE 1100 on a hardware platform such as platform 900 of FIG. 9. A TEE 1100 is a combination of hardware, software, and/or memory allocation that provides the ability to securely execute instructions without interference from outside processes, in a verifiable way. By way of example, TEE 1100 may include memory enclave 1140 or some other protected memory area, and a secure processing engine 1110, which includes hardware, software, and instructions for accessing and operating on enclave 1140. Nonlimiting examples of solutions that either are or that can provide a TEE include Intel SGX, ARM TrustZone, AMD Platform Security Processor, Kinibi, securiTEE, OP-TEE, TLK, T6, Open TEE, SierraTEE, CSE, VT-x, MemCore, Canary Island, Docker, and Smack. Thus, it should be noted that in an example, secure processing engine 1110 may be a user-mode application that operates via trusted execution framework 1124 within enclave 1140. TEE 1100 may also conceptually include processor instructions that secure processing engine 1110 and trusted execution framework 1124 require to operate within enclave 1140.

Secure processing engine 1110 and trusted execution framework 1124 may together form a TCB, which is a set of programs or computational units that are trusted to be secure. Conceptually, it may be advantageous to keep TCB relatively small so that there are fewer attack vectors for malware objects or for negligent software. Thus, for example, operating system 1122 may be excluded from TCB, in addition to the regular application stack 1128 and application code 1130.

In certain systems, computing devices equipped with Intel SGX or equivalent instructions may be capable of providing an enclave 1140. It should be noted, however, that many other examples of TEEs are available, and TEE 1100 is provided only as one example thereof. Other secure environments may include, by way of nonlimiting example, a virtual machine, sandbox, testbed, test machine, or other similar device or method for providing a TEE 1100.

In an example, enclave 1140 provides a protected memory area that cannot be accessed or manipulated by ordinary computer instructions. Enclave 1140 is described with particular reference to an Intel SGX enclave by way of example, but it is intended that enclave 1140 encompass any secure processing area with suitable properties, regardless of whether it is called an “enclave.”

One feature of an enclave is that once an enclave region 1140 of memory 1120 is defined, as illustrated, a program pointer cannot enter or exit enclave 1140 without the use of special enclave instructions or directives, such as those provided by Intel SGX architecture. For example, SGX™ processors provide the ENCLU[EENTER], ENCLU[ERESUME], and ENCLU[EEXIT]. These are the only instructions that may legitimately enter into or exit from enclave 1140.

Thus, once enclave 1140 is defined in memory 904, a program executing within enclave 1140 may be safely verified to not operate outside of its bounds. This security feature means that secure processing engine 1110 is verifiably local to enclave 1140. Thus, when an untrusted packet provides its content to be rendered with trusted execution framework 1124 of enclave 1140, the result of the rendering is verified as secure.

Enclave 1140 may also digitally sign its output, which provides a verifiable means of ensuring that content has not been tampered with or modified since being rendered by secure processing engine 1110. A digital signature provided by enclave 1140 is unique to enclave 1140 and is unique to the hardware of the device hosting enclave 1140.

FIG. 12 is a block diagram of a NFV infrastructure 1200. NFV is an aspect of network virtualization that is generally considered distinct from, but that can still interoperate with, SDN. Virtualization may be used to realize any of the compute functions disclosed herein. In particular, server functions are often virtualized, although client and endpoint functions can also be virtualized.

For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be virtual machines). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 1200. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 12, an NFV orchestrator 1201 manages a number of the VNFs 1212 running on an NFVI 1200. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 1201 a valuable system resource. Note that NFV orchestrator 1201 may provide a browser-based or graphical configuration interface, and in some embodiments may be integrated with SDN orchestration functions.

Note that NFV orchestrator 1201 itself may be virtualized (rather than a special-purpose hardware appliance). NFV orchestrator 1201 may be integrated within an existing SDN system, wherein an operations support system (OSS) manages the SDN. This may interact with cloud resource management systems (e.g., OpenStack) to provide NFV orchestration. An NFVI 1200 may include the hardware, software, and other infrastructure to enable VNFs to run. This may include a hardware platform 1202 on which one or more VMs 1204 may run. For example, hardware platform 1202-1 in this example runs VMs 1204-1 and 1204-2. Hardware platform 1202-2 runs VMs 1204-3 and 1204-4. Each hardware platform may include a hypervisor 1220, virtual machine manager (VMM), or similar function, which may include and run on a native (bare metal) operating system, which may be minimal so as to consume very few resources.

Hardware platforms 1202 may be or comprise a rack or several racks of blade or slot servers (including, e.g., processors, memory, and storage), one or more data centers, other hardware resources distributed across one or more geographic locations, hardware switches, or network interfaces. An NFVI 1200 may also include the software architecture that enables hypervisors to run and be managed by NFV orchestrator 1201.

Running on NFVI 1200 are a number of VMs 1204, each of which in this example is a VNF providing a virtual service appliance. Each VM 1204 in this example includes an instance of the Data Plane Development Kit (DPDK), a virtual operating system 1208, and an application providing the VNF 1212.

Virtualized network functions could include, as nonlimiting and illustrative examples, firewalls, intrusion detection systems, load balancers, routers, session border controllers, DPI services, network address translation (NAT) modules, or call security association.

The illustration of FIG. 12 shows that a number of VNFs 1204 have been provisioned and exist within NFVI 1200. This FIGURE does not necessarily illustrate any relationship between the VNFs and the larger network, or the packet flows that NFVI 1200 may employ.

The illustrated DPDK instances 1216 provide a set of highly-optimized libraries for communicating across a virtual switch (vSwitch) 1222. Like VMs 1204, vSwitch 1222 is provisioned and allocated by a hypervisor 1220. The hypervisor uses a network interface to connect the hardware platform to the data center fabric (e.g., an HFI). This HFI may be shared by all VMs 1204 running on a hardware platform 1202. Thus, a vSwitch may be allocated to switch traffic between VMs 1204. The vSwitch may be a pure software vSwitch (e.g., a shared memory vSwitch), which may be optimized so that data are not moved between memory locations, but rather, the data may stay in one place, and pointers may be passed between VMs 1204 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 1222 is illustrated, wherein vSwitch 1222 is shared between two or more physical hardware platforms 1202.

FIG. 13 is a block diagram of selected elements of a containerization infrastructure 1300. Like virtualization, containerization is a popular form of providing a guest infrastructure. Containerization may be used, for example, to replace or supplement virtualization.

Containerization infrastructure 1300 runs on a hardware platform such as containerized server 1304. Containerized server 1304 may provide a number of processors, memory, one or more network interfaces, accelerators, and/or other hardware resources.

Running on containerized server 1304 is a shared kernel 1308. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1308 is main operating system 1312. Commonly, main operating system 1312 is a Unix or Linux-based operating system, although containerization infrastructure is also available for other types of systems, including Microsoft Windows systems and Macintosh systems. Running on top of main operating system 1312 is a containerization layer 1316. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer versus one without a daemon, like Podman. Such debates are outside the scope of the present specification, and when the present specification speaks of containerization, it is intended to include containerization layers, whether or not they require the use of a daemon.

Main operating system 1312 may also include a number of services 1318, which provide services and interprocess communication to userspace applications 1320.

Services 1318 and userspace applications 1320 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1312, they inherit the same file and resource access permissions as those provided by shared kernel 1308. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 1304, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 1304).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors—especially type 1, or “bare metal,” hypervisors—provide such near-native performance that this advantage may not always be realized.

In this example, containerized server 1304 hosts two containers, namely container 1330 and container 1340.

Container 1330 may include a minimal operating system 1332 that runs on top of shared kernel 1308. Note that a minimal operating system is provided as an illustrative example, and is not mandatory. In fact, container 1330 may perform as full an operating system as is necessary or desirable. Minimal operating system 1332 is used here as an example simply to illustrate that in common practice, the minimal operating system necessary to support the function of the container (which in common practice, is a single or monolithic function) is provided.

On top of minimal operating system 1332, container 1330 may provide one or more services 1334. Finally, on top of services 1334, container 1330 may also provide a number of userspace applications 1336, as necessary.

Container 1340 may include a minimal operating system 1342 that runs on top of shared kernel 1308. Note that a minimal operating system is provided as an illustrative example, and is not mandatory. In fact, container 1340 may perform as full an operating system as is necessary or desirable. Minimal operating system 1342 is used here as an example simply to illustrate that in common practice, the minimal operating system necessary to support the function of the container (which in common practice, is a single or monolithic function) is provided.

On top of minimal operating system 1342, container 1340 may provide one or more services 1344. Finally, on top of services 1344, container 1340 may also provide a number of userspace applications 1346, as necessary.

Using containerization layer 1316, containerized server 1304 may run a number of discrete containers, each one providing the minimal operating system and/or services necessary to provide a particular function. For example, containerized server 1304 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

The foregoing outlines features of several embodiments so that those skilled in the art may better understand various aspects of the present disclosure. The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, nontransitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, nontransitory computer-readable storage media having stored thereon executable instructions that, when executed, cause a hardware platform or other computing system, to carry out a method or procedure. For example, the instructions could be executable object code, including software instructions executable by a processor. The one or more tangible, nontransitory computer-readable storage media could include, by way of illustrative and nonlimiting example, a magnetic media (e.g., hard drive), a flash memory, a ROM, optical media (e.g., CD, DVD, Blu-Ray), nonvolatile random access memory (NVRAM), nonvolatile memory (NVM) (e.g., Intel 3D Xpoint), or other nontransitory memory.

There are also provided herein certain methods, illustrated for example in flow charts and/or signal flow diagrams. The order or operations disclosed in these methods discloses one illustrative ordering that may be used in some embodiments, but this ordering is no intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected element. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

In order to aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

1. A computing apparatus, comprising:
a hardware platform comprising a processor and a memory; and
instructions encoded within the memory to:
identify an online transaction involving a user;
according to a plurality of contextual factors, determine a sensitivity level for the online transaction; and
according to the sensitivity level, contextually increase security for the online transaction without altering at least one other online transaction.

2. The computing apparatus of claim 1, wherein the sensitivity level is selected from a set of discrete sensitivity levels.

3. The computing apparatus of claim 1, wherein one of the plurality of contextual factors is a user profile.

4. The computing apparatus of claim 1, wherein one of the plurality of contextual factors is a task type.

5. The computing apparatus of claim 1, wherein one of the plurality of contextual factors is an online service associated with the online transaction.

6. The computing apparatus of claim 1, wherein one of the plurality of contextual factors is a network on which the online transaction occurs.

7. The computing apparatus of claim 1, wherein one of the plurality of contextual factors is a device context.

8. The computing apparatus of claim 1, wherein one of the plurality of contextual factors is a browser context.

9. The computing apparatus of claim 1, wherein contextually increasing security comprises disabling a key logger or screen grabber.

10. The computing apparatus of claim 1, wherein contextually increasing security comprises adding one or more layers of authentication.

11. The computing apparatus of claim 1, wherein contextually increasing security comprises auto-filling or clearing at least one field of a web form that calls for personally-identifying information.

12. The computing apparatus of claim 11, wherein the at least one field is a non-mandatory field.

13. The computing apparatus of claim 1, wherein contextually increasing security comprises hardening a web browser environment.

14. The computing apparatus of claim 1, wherein contextually increasing security comprises enabling a VPN tunnel.

15-19. (canceled)

20. One or more tangible, nontransitory computer-readable storage media having stored thereon executable instructions to:
identify an online transaction for an end-user device, wherein the online transaction is associated with data associated with a user;
compute or receive a plurality of contextual factors associated with the online transaction;
determine a sensitivity level for the online transaction according to the plurality of contextual factors; and
according to the sensitivity level, specifically increase security for the online transaction without affecting security of at least one other online transaction of the end-user device.

21-33. (canceled)

35. The one or more tangible, nontransitory computer-readable media of claim 20, wherein contextually increasing security comprises handling the online transaction via a remote cloud-based browser.

36. The one or more tangible, nontransitory computer-readable media of claim 20, wherein determining the sensitivity level comprises querying a cloud reputation service for a category of a URL associated with the online transaction.

37. (canceled)

38. The one or more tangible, nontransitory computer-readable media of claim 20, wherein determining the sensitivity level comprises querying a cloud reputation service for a reputation of at least one of a URL, a browser extension, an application, a merchant, or a public network.

39. A method of providing holistic transaction security on an end-user device, comprising:
identifying, on the end-user device, an online transaction including associated with a user;
computing or receiving a plurality of contextual factors associated with the online transaction;
determining a sensitivity level for the online transaction according to the plurality of contextual factors; and
according to the sensitivity level, specifically increasing security for the online transaction without affecting security of at least one other online transaction of the end-user device.

40. The method of claim 39, wherein the sensitivity level is selected from a set of discrete sensitivity levels.

41-62. (canceled)
